(19) United States
(12) Patent Application Publication
(10) Pub. No.: US 2008/0171658 A1
(43) Pub. Date: Jul. 17, 2008

(54) Method For Producing Aqueous Polymer Dispersions Containing Pesticides And Use Thereof

(75) Inventors: Rainer Dyllick-Brenzinger, Speyer (DE); Matthias Bratz, Maxdorf (DE); Christian Kruger, Saulheim (DE); Gunter Oetter, Frankenthal (DE); Felix Christian Gorth, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellshaft, Ludwigshafen (DE)

(21) Appl. No.: 11/908,234

(22) PCT Filed: Mar. 7, 2006
(86) PCT No.: PCT/EP2006/060516

§ 371 Date: Sep. 10, 2007

(30) Foreign Application Priority Data
Mar. 10, 2005 (EP) PCT/EP2005/002533

(51) Int. Cl. A01N 25/04; A01C 1/06

(52) U.S. Cl. 504/100; 424/405; 504/363

(57) ABSTRACT

Process for the preparation of pesticide-comprising aqueous polymer dispersions with an average particle size of the dispersed particles of <1000 nm by radical polymerization of an oil-in-water emulsion, the oil phase of which comprises at least one pesticide in at least one ethylenically unsaturated monomer, a solution of at least one pesticide in at least one monomer being emulsified in water in the presence of at least one surface-active agent to give a miniemulsion with an average particle size <500 nm and/or at least one pesticide being added during the emulsification or subsequently and the miniemulsion subsequently being polymerized under radical conditions, and the use of the dispersions which can thus be obtained for combating harmful microorganisms and/or for regulating the growth of plants and/or for combating undesirable plant growth and/or for combating undesirable insect or acarid infestation on plants and/or for combating phytopathogenic fungi and/or for seed treatment.

The invention relates to a process for the preparation of pesticide-comprising aqueous polymer dispersions with a mean particle size of the dispersed particles of <1000 nm by radical polymerization of an oil-in-water emulsion, the oil phase of which comprises at least one pesticide in at least one ethylenically unsaturated monomer, and to the use of the dispersions for combating harmful microorganisms and/or for regulating the growth of plants and/or for combating undesirable plant growth and/or for combating undesirable insect or acarid infestation on plants and/or for combating phytopathogenic fungi and/or for seed treatment.

Aqueous polymer dispersions comprising functional substances, such as, in particular, UV absorbers or epoxide resins, are known from JP-A-7-292009. They are prepared by dissolution of the functional substances in an unsaturated monomer, emulsification of this solution in water in the presence of a surface-active agent, to give a monomer emulsion with average particle sizes between 5 and 500 nm, and polymerization of the miniemulsion in the presence of a radical initiator. The aqueous dispersions comprising the functional substances, such as UV absorbers, epoxide resins, acrylic-based polymers, phenolic resins, unsaturated polyesters, phenol-based substances and petroleum resins, are used as binders and as additive for protective coating films.

WO 99/40123 discloses a process for the preparation of aqueous polymer dispersions, the dispersed polymer particles of which comprise an organic colorant which is homogenously distributed, i.e. molecularly dispersed. Such aqueous dispersions are prepared by miniemulsion polymerization by polymerizing ethylenically unsaturated monomers, which comprise a dissolved organic colorant, in the form of an oil-in-water emulsion in the presence of radical-forming polymerization initiators, the disperse phase of the emulsion being essentially composed of colorant-comprising monomer droplets with a diameter <500 nm. In an advantageous embodiment of the invention, use is made, in the polymerization, of monomer mixtures comprising monomers with a crosslinking effect. The polymer dispersions are stable toward sedimentation. The dispersed particles have a mean particle size of 100 to 400 nm. They can be isolated from the aqueous dispersions using conventional drying methods. The colorant-comprising polymer dispersions are used, for example, for the pigmenting of high molecular weight organic and inorganic materials and for the pigmenting of printing inks and of inks for ink jet printing.

EP-A-1 092 416 discloses the use of finely divided aqueous polymer dispersions comprising colorants, fluorescent whitening agents or UV absorbers or a pulverulent polymer obtainable therefrom, the polymer matrix of which comprises colorants, fluorescent whitening agents or UV absorbers homogenously distributed, as coloring constituent in cosmetic compositions. The dispersions are preferably prepared, according to the process known from WO-A-99/40123, by miniemulsion polymerization of ethylenically unsaturated monomers comprising a dissolved colorant, fluorescent whitening agent or UV absorber.

Additional colorant-comprising polymer dispersions, the colorant-comprising polymer particles of which have a mean particle size of less than 1000 nm, are known from EP-A-1 191 041. In addition to organic colorants, UV absorbers and fluorescent whitening agents are also suitable as colorants. They are prepared by dissolving a colorant in at least one ethylenically unsaturated monomer, emulsifying this solution in water with formation of a conventional macroemulsion, homogenizing the macroemulsion with formation of a miniemulsion with a mean particle size of less than 1000 nm and polymerizing the miniemulsion in the presence of a radical-forming polymerization initiator, 0.1 to 20% by weight of at least one nonionic surface-active compound and 1 to 50% by weight, in each case with reference to the monomers used, of at least one amphiphilic polymer. The polymer particles comprise 0.5 to 50% by weight of at least one organic colorant, fluorescent whitening agent or UV absorber which is homogenously distributed, which should be understood as meaning that the organic colorants are dissolved monomolecularly in the polymer matrix or are present in the form of bimolecular or polymolecular aggregates.

WO 01/10936 discloses particles with a core/shell structure, in which the core comprises a polymer with a glass transition temperature T_{g} of less than 40° C. and a UV absorber and the shell preferably consists of a polymer from methyl acrylate, ethyl acrylate, ethyl methacrylate and/or methyl methacrylate. The polymer forming the core of the particle can, if appropriate, be crosslinked. The polymer particles are prepared by emulsion polymerization. The polymer particles comprising UV absorber are used to prepare polymer compositions which absorb UV radiation.

WO 2004/037867 discloses aqueous polymer dispersions comprising alkyldiketenes which can be obtained by miniemulsion polymerization of hydrophobic monoethylenically unsaturated monomers in the presence of alkyldiketenes. These dispersions are used as sizing agents for paper and as hydrophobizing agents for leather, natural and/or synthetic fibers and textiles.

WO 2004/046234 discloses the use of finely divided polymer powders comprising at least one UV absorber for stabilizing polymers against the effect of UV radiation. The polymer particles of the polymer powders have a particle size of 500 nm or less. They are preferably prepared by miniemulsion polymerization according to processes known from the abovementioned documents WO 99/40123, EP-A 1 092 415 and EP-A 1 191 041. The polymer particles comprise 0.5 to 50% by weight of at least one UV absorber which is either present therein homogeneously distributed in molecular or nanocrystalline form or else is completely or only partially coated therein with the polymer matrix.

U.S. Pat. No. 6,309,787 discloses a process for encapsulating colorants by miniemulsion polymerization, the miniemulsion being prepared in the presence of a surface-active agent, a cosurfactant and a nonionic surface-active agent. After polymerization, dispersed particles are obtained which are formed from a colorant core and a polymer shell.

DE-A 196 28 143 discloses a process for the preparation of an aqueous polymer dispersion. The polymerization of the monomers is carried out after the style of a radical aqueous miniemulsion polymerization in which at least a portion of the aqueous monomer miniemulsion is continuously introduced into the polymerization region with continual polymerization.

The prior application 10 2004 012 576.7 discloses aqueous polymer dispersions comprising effect substances with a mean particle size of the dispersed particles of <500 nm, the polymer particles comprising a polymer matrix formed from at least one ethylenically unsaturated monomer as core and an effect substance which is soluble in the monomers forming the polymer matrix of the particles being positioned, at least partially, on the surface of the core. These polymer dispersions are prepared by first preparing a miniemulsion by emulsifying ethylenically unsaturated monomers in water in the presence of at least one effect substance and one surface-active agent with a mean particle size of the emulsified particles of <500 nm and polymerizing it in such a way, in the presence of at least one radical polymerization initiator, that first only a maximum of 50% of the monomers polymerize which are found in the polymerization region, the effect substances migrating to the surface of the emulsified particles, and the polymerization is brought to completion only after extensive or complete accumulation of the effect substances at the surface of the polymer particles produced. The dispersions which can be obtained in this way and the polymer powders produced therefrom by evaporation of the volatile constituents are used, for example, for stabilizing polymers against the effect of UV radiation, oxygen and heat, in cosmetic and pharmaceutical formulations, in surface coatings, in the preparation of paper, leather and textiles and in formulations for feeding animals.

In plant protection, pesticides which exhibit only a slight solubility in water are frequently formulated in the form of aqueous suspensions or emulsions. While emulsions usually still comprise organic solvents, suspensions are usually formulated without solvents. The active substance is present in these suspensions in the form of fine particles with particle sizes in the μm range.

The proposal has occasionally been made to formulate water-insoluble fungicidal active substances in the form of aqueous microemulsions (see e.g. WO 02/082900, WO 02/45507 and WO 99/65301). In contrast to conventional, usually milky-cloudy, macroemulsions in which the dispersed phase exhibits droplet sizes plainly of more than 1 μm, the active substances are present in the clear to opaque microemulsions in finely divided form with droplet sizes plainly of less than 1000 nm down to 10 nm or less [see in this connection D. J. Shaw, Introduction to Colloid and Surface Chemistry, Butterworths, London, 1986, p. 273].

The prior DE application 10 2004 020 332.6 discloses an aqueous active substance composition which has at least one fungicidal organic active substance with a solubility in water of not more than 5 g/l at 25° C. and 1013 mbar and a finely divided polymer with a mean particle size of not more than 300 nm, the polymer particles comprising the active substance. The polymer is formed from at least 60% by weight of at least one neutral monoethylenically unsaturated monomer with a solubility in water of not more than 30 g/l at 25° C. and up to 40% by weight, in each case with reference to the total amount of the monomers, of at least one other ethylenically unsaturated monomer. Such active substance compositions are accessible by radical aqueous emulsion polymerization of an oil-in-water emulsion of the ethylenically unsaturated monomers which comprise at least one fungicidal active substance and, if appropriate, one insecticidal active substance. However, the stability of the aqueous dispersions is still in need of improvement.

It is an object of the present invention to make available a process for the preparation of aqueous polymer dispersions comprising agrochemical active substances which release the agrochemical active substances in a controlled fashion in the respective application or else make them available in a form stable toward migration or protect them from decomposition.

This object is achieved according to the invention with a process for the preparation of pesticide-comprising aqueous polymer dispersions with a mean particle size of the dispersed particles of <1000 nm by radical polymerization of an oil-in-water emulsion, the oil phase of which comprises at least one active substance in at least one ethylenically unsaturated monomer, if a solution of at least one pesticide in at least one monomer is emulsified in water in the presence of at least one surface-active agent, to give a miniemulsion with a mean droplet size <500 nm, and/or at least one pesticide is added during the emulsification or subsequently, and the miniemulsion is subsequently polymerized under radical conditions.

The particle sizes of the finely divided polymer given here are weight-average particle sizes, such as can be determined by dynamic light scattering. Methods for this are familiar to a person skilled in the art, for example from H. Wiese in D. Distler, Wässrige Polymerdispersionen [Aqueous polymer dispersions], Wiley-VCH, 1999, chapter 4.2.1, p. 40ff, and the literature cited therein, and also H. Auweter and D. Horn, J. Colloid Interf. Sci., 105 (1985), 399, D. Lilge and D. Horn, Colloid Polym. Sci., 269 (1991), 704, or H. Wiese and D. Horn, J. Chem. Phys., 94 (1991), 6429. The mean particle size preferably ranges from 10 to 250 nm, in particular ranges from 20 to 200 nm, particularly preferably ranges from 30 to 150 nm and very particularly preferably ranges from 30 to 100 nm.

Pesticides are known to a person skilled in the art from the literature. The term “pesticide” means here at least one active substance chosen from the group consisting of the insecticides, fungicides, herbicides, growth regulators and safeners (see Pesticide Manual, 13th Ed. (2003)).

The pesticide used as active substance is preferably an organic pesticide with a low solubility in water generally of not more than 5 g/l, preferably of not more than 3 g/l. The following list of insecticides demonstrates possible active substances but should not be limited to these:
organo(thio)phosphates, such as acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, triazophos or trichlorfon;
carbamates, such as alanycarb, benfuracarb, bendiocarb, carbaryl, carbosulfan, fenoxycarb, furathiocarb, indoxacarb, methiocarb, methomyl, oxamyl, pirimicarb, propoxur, thiodicarb or triazamate;
pyrethroids, such as allethrin, bifenthrin, cyfluthrin, cyphenothrin, cypermethrin and the alpha, beta, theta and zeta isomers, deltamethrin, esfenvalerate, etofenprox, fenpropathrin, fenvalerate, cyhalothrin, lambda-cyhalothrin, imiprothrin, permethrin, prallethrin, pyrethrin I, pyrethrin II, silafluofen, taufluvalinate, tefluthrin, tetramethrin, tralomethrin or transfluthrin;
arthropodal growth regulators, such as a) chitin synthesis inhibitors, e.g. benzoylureas, such as chlorfluazuron, cyromazine, diflubenzuron, flucycloxuron, flufenoxuron, hexaflumuron, lufenuron, novaluron, teflubenzuron, triflumuron, buprofezin, diofenolan, hexythiazox, etoxazole or clofentezine; b) ecdysone antagonists, such as halofenozide, methoxyfenozide or tebufenozide; c) juvenile hormone mimics, such as pyriproxyfen, methoprene or fenoxycarb; d) lipid biosynthesis inhibitors, such as spirodiclofen;
neonicotinoids, such as flonicamid, clothianidin, dinotefuran, imidacloprid, thiamethoxam, nitenpyram, nithiazine, acetamiprid or thiacloprid;
pryazole insecticides, such as acetoprole, ethiprole, fipronil, tebufenpyrad, tolfenpyrad and vaniliprole;
furthermore abamectin, acequinocyl, amitraz, azadirachtin, bifenazate, cartap, chlorfenapyr, chlordimeform, cyromazine, diafenthiuron, diofenolan, emamectin, endosulfan, fenazaquin, formetanate, formetanate hydrochloride, hydramethylnon, piperonyl butoxide, pyridaben, pymetrozine, spinosad, thiamethoxam, thiocyclam, pyridalyl, flonicamid, fluacrypyrim, milbemectin, spiromesifen, flupyrazofos, NC 512, tolfenpyrad, flubendiamide, bistrifluoron, benclothiaz, pyrafluprole, pyriprole, amidoflumet, flufenerim, cyflumetofen, acequinocyl, lepimectin, profluthrin, dimefluthrin, amidrazone, metaflumizone, N-ethyl-2,2-dichloro-1-methylcyclopropanecarboxamide 2-(2,6-dichloro-α,α,α-trifluoro-p-tolyl)hydrazone, N-ethyl-2,2-dimethylpropionamide 2-(2,6-dichloro-α,α,α-trifluoro-p-tolyl)hydrazone, compound of the following formula

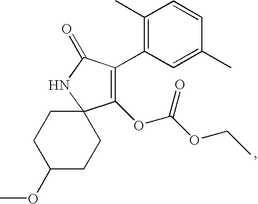

aminoisothiazole of the formula

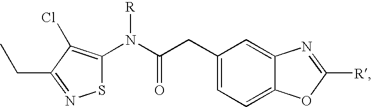

in which

### R═—CH₂OCH₃ or H, and

### R′═—CF₂CF₂CF₃;

anthranilamide of the formula

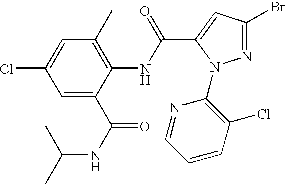

and an insecticidal active compound of the following formula

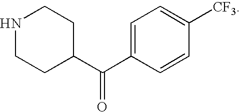

The following list of fungicides shows possible active substances but should not be limited to these:
acylalanines, e.g. benalaxyl, furalaxyl, metalaxyl, ofurace or oxadixyl;
amine derivatives, e.g. aldimorph, dodine, dodemorph, fenpropimorph, fenpropidin, guazatine, iminoctadine, spiroxamine or tridemorph;
anilinopyrimidines, e.g. pyrimethanil, mepanipyrim or cyprodinil;
antibiotics, e.g. cycloheximide, griseofulvin, kasugamycin, natamycin, polyoxin, streptomycin or validamycin A;
azoles, e.g. bitertanol, bromuconazole, cyazofamid, cyproconazole, difenoconazole, diniconazole, epoxiconazole, etridiazole, fenbuconazole, fluquinconazole, flusilazole, flutriafol, fuberidazole, hexaconazole, hymexazol, imazalil, imibenconazole, metconazole, myclobutanil, penconazole, pefurazoate, propiconazole, prochloraz, prothioconazole, simeconazole, tebuconazole, tetraconazole, thiabendazole, triadimefon, triadimenol, triflumizole, triticonazole, 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one or 3-(3-bromo-6-fluoro-2-methylindol-1-ylsulfonyl)-[1,2,4]triazole-1-sulfonic acid dimethylamide;
dicarboximides, e.g. iprodione, myclozolin, procymidone or vinclozolin;
heterocyclic compounds, e.g. anilazine, benomyl, boscalid, carbendazim, carboxin, oxycarboxin, cyazofamid, dazomet, dithianon, ethirimol, dimethirimol, famoxadone, fenamidone, fenarimol, fuberidazole, flutolanil, furametpyr, isoprothiolane, mepronil, nuarimol, octhilinone, probenazole, proquinazid, pyrifenox, pyroquilon, quinoxyfen, silthiofam, thiabendazole, thifluzamide, thiophanate-methyl, tiadinil, tricyclazole, triforine, 3-[5-(4-chlorophenyl)-2,3-dimethylisoxazolidin-3-yl]pyridine or bupirimate;
nitrophenyl derivatives, e.g. binapacryl, dinocap, dinobutone or nitrothal-isopropyl;
phenylpyrroles, e.g. fenpiclonil or fludioxonil;
organic phosphorus compounds, e.g. edifenphos, iprobenfos, pyrazophos, tolclofos-methyl, fosetyl, fosetyl-aluminum or phosphorous acid;
other fungicides, e.g. acibenzolar-5-methyl, benthiavalicarb, carpropamid, chlorothalonil, cyflufenamid, cymoxanil, dazomet, diclomezine, diclocymet, diethofencarb, ethaboxam, fenhexamid, fentin acetate, fenoxanil, ferimzone, fluazinam, fosetyl, fosetyl-aluminum, iprovalicarb, hexachlorobenzene, metrafenone, pencycuron, propamocarb, phthalide, tolclofos-methyl, quintozene, zoxamide, isoprothiolane, iprobenfos, fluopicolide (picobenzamid), mandipropamid, N-(2-{4-[3-(4-chlorophenyl)prop-2-ynyloxy]-3-methoxyphenyl}ethyl)-2-methylsulfonylamino-3-methylbutyramide, N-(2-{4-[3-(4-chlorophenyl)prop-2-ynyloxy]-3-methoxyphenyl}ethyl)-2-ethylsulfonylamino-3-methylbutyramide, furametpyr, thifluzamide, penthiopyrad, fenhexamid, 3,4-dichloroisothiazole-5-carboxylic acid (2-cyanophenyl)amide, flubenthiavalicarb, 3-(4-chlorophenyl)-3-(2-isopropoxycarbonylamino-3-methylbutyrylamino)propionic acid methyl ester, {2-chloro-5-[1-(6-methylpyridin-2-ylmethoxyimino)ethyl]benzyl}carbamic acid methyl ester, {2-chloro-5-[1-(3-methylbenzyloxyimino)ethyl]benzyl}carbamic acid methyl ester or flusulfamide,
   amides of the formula

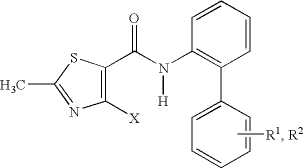

in which

### X is CHF₂ or CH₃, and

R¹ and R² are, independently of one another, halogen, methyl or halomethyl;
strobilurins, e.g. azoxystrobin, dimoxystrobin, enestroburin, fluoxastrobin, kresoxim-methyl, metominostrobin, orysastrobin, picoxystrobin, pyraclostrobin or trifloxystrobin;
sulfenic acid derivates, e.g. captafol, captan, dichlorfluanid, folpet or tolylfluanid;
cinnamamides and analogs, e.g. dimethomorph, flumetover or flumorph;
amide fungicides, e.g. cyflufenamid or (Z)-N-[α-(cyclopropylmethoxyimino)-2,3-difluoro-6-(difluoromethoxy)benzyl]-2-phenylacetamide.

The following list of herbicides demonstrates possible active substances but should not be limited to these:
compounds which inhibit the biosynthesis of lipids, e.g. chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cyciloxydim, profoxydim, sethoxydim, tepraloxydim, tralkoxydim, butylate, cycloate, di-allate, dimepiperate, EPTC, esprocarb, ethiolate, isopolinate, methiobencarb, molinate, orbencarb, pebulate, prosulfocarb, sulfallate, thiobencarb, thiocarbazil, tri-allate, vernolate, benfuresate, ethofumesate and bensulide;

ALS inhibitors, such as amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;

compounds which inhibit photosynthesis, such as atraton, atrazine, ametryn, aziprotryn, cyanazine, cyanatryn, chlorazine, cyprazine, desmetryn, dimethametryn, dipropetryn, eglinazine, ipazine, mesoprazine, methometon, methoprotryne, procyazine, proglinazine, prometon, prometryn, propazine, sebuthylazine, secbumeton, simazine, simeton, simetryn, terbumeton, terbuthylazine and terbutryn;
protoporphyrinogen IX oxidase inhibitors, such as acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen and etnipromid;
herbicides, such as metflurazon, norflurazon, flufenican, diflufenican, picolinafen, beflubutamid, fluridone, fluorochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethylphenoxy)-2-(4-trifluoromethylphenyl)pyrimidine and 4-heterocyclyl-substituted benzoyl derivatives of the formula (cf. WO-A-96/26202, WO-A-97/41116, WO-A-97/41117 and WO-A-97/41118)

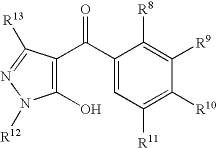

in which the substituents R⁸ to R¹³ have the following meanings:
R⁸, R¹⁰ represent hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl;
R⁹ represents a heterocyclic radical from the group consisting of thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, in which the abovementioned radicals can carry one or more substituents, e.g. can be mono-, di-, tri- or tetrasubstituted by halogen, C₁-C₄-alkyl, C₁-C₄-alkoxy, C₁-C₄-haloalkyl, C₁-C₄-haloalkoxy or C₁-C₄-alkylthio;
R¹¹ represents hydrogen, halogen or C₁-C₆-alkyl;
R¹² represents C₁-C₆-alkyl;
R¹³ represents hydrogen or C₁-C₆-alkyl.

Additional suitable herbicides are EPSP synthase inhibitors, such as glyphosate;

glutamine synthase inhibitors, such as glufosinate and bilanafos;
DHP synthase inhibitors, such as asulam;
mitosis inhibitors, such as benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, ohlorthal, carbetamide, chlorbufam, chlorpropham and propham;
VLCFA inhibitors, such as acetochlor, alachlor, butachlor, butenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane;
inhibitors for the biosynthesis of cellulose, such as dichlobenil, chlorthiamid, isoxaben and flupoxam;
herbicides, such as dinofenate, dinoprop, dinosam, dinoseb, dinoterb, DNOC, etinofen and medinoterb;
auxin herbicides, such as clomeprop, 2,4-D, 2,4,5-T, MCPA, MCPA-thioethyl, dichlorprop, dichlorprop-P, mecoprop, mecoprop-P, 2,4-DB, MCPB, chloramben, dicamba, 2,3,6-TBA, tricamba, quinclorac, quinmerac, clopyralid, fluoroxypyr, picloram, triclopyr and benazolin;
auxin transport inhibitors, such as naptalam and diflufenzopyr;
in addition: benzoylprop, flamprop, flamprop-M, bromobutide, chlorflurenol, cinmethylin, methyldymron, etobenzanid, fosamine, metam, pyributicarb, oxaziclomefone, dazomet, triaziflam and methyl bromide.

The term “safener” has the following meaning: it is known that, in some cases, better herbicidal tolerance can be achieved by the joint application of herbicides having a specific action with organic active compounds which themselves can exert a herbicidal effect. In these cases, these compounds act as antidote or antagonist and, because they reduce or avert damage to useful plants, are described as “safeners”.

The following list demonstrates possible safeners but should not be limited to these:

benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67; MON 4660) and oxabetrinil.

The following list of compounds with a growth-regulating effect demonstrates possible active substances but should not be limited to these:

1-naphthaleneacetamide, 1-naphthaleneacetic acid, 2-naphthoxyacetic acid, 3-CPA, 4-CPA, ancymidol, anthraquinone, BAP, butifos, tribufos, butralin, chlorflurenol, chlormequat, clofencet, cyclanilide, daminozide, dicamba, dikegulac-sodium, dimethipin, chlorfenethol, etacelasil, ethephone, ethychlozate, fenoprop, 2,4,5-TP, fluoridamid, flurprimidol, flutriafol, gibberellic acid, gibberellin, guazatine, imazalil, indolebutyric acid, indoleacetic acid, karetazan, kinetin, lactidichlor-ethyl, maleic hydrazide, mefluidide, mepiquat chloride, naptalam, paclobutrazol, prohexadione-calcium, quinmerac, sintofen, tetcyclacis, thidiazuron, triiodobenzoic acid, triapenthenol, triazethan, tribufos, trinexapac-ethyl and uniconazole.

The miniemulsion polymerization of ethylenically unsaturated monomers in the presence of oil-soluble colorants is known, for example from WO-A-99/40123, cited in the state of the art. Page 3, line 30 to page 38, line 6, and page 69, line 11, to page 84, line 43, of WO-A-99/40123 are referred to in particular for details of this polymerization method and of the monomers. This part of the WO application is herewith made by reference to the disclosure content of the present invention. The ethylenically unsaturated monomers, auxiliaries and processing measures for the preparation of the miniemulsion described therein are used in an identical way in the process according to the invention, except that use is made of active substances according to the invention which are conventionally used for combating harmful microorganisms, for regulating the growth of plants, for combating undesirable plant growth, for combating undesirable insect or acarid infestation on plants, for combating phytopathogenic fungi and/or for seed treatment in order to protect from infection and damage by microorganisms.

The oil phase of the miniemulsion comprises, for example, 0.5 to 60% by weight, preferably 10 to 40% by weight, in particular 10 to 30% by weight, with reference to the total amount of monomers used, of at least one active substance.

Suitable ethylenically unsaturated monomers are, for example:
(a) 50 to 100% by weight of at least one ethylenically unsaturated monomer A with a solubility in water of >0.01 g/l at 25° C. and 1013 mbar,
(b) 0 to 50% by weight of at least one ethylenically unsaturated monomer B with a solubility in water of <0.01 g/l at 25° C. and 1013 mbar and
(c) 0 to 30% by weight of at least one ethylenically unsaturated monomer C with at least two double bonds.

These monomers or combinations of monomers are described in detail in the abovementioned WO-A-99/40123. Individual monomers from groups (a) to (c) should be mentioned purely by way of example, in fact, as monomers from group (a), styrene, α-methylstyrene, vinyl acetate, vinyl propionate, dimethyl maleate, diethyl maleate, esters of ethylenically unsaturated C₃- to C₅-carboxylic acids and monovalent alcohols with 1 to 6 carbon atoms, and allyl acetate.

The monomers (a) also comprise those monomers A′ which exhibit an increased solubility in water, i.e. >60 g/l at 25° C. and 1013 mbar. The monomers A′ are used to modify the polymers and are generally involved in the synthesis of the polymer matrix in amounts of 0.1 up to 20% by weight, preferably of 0.5 to 10% by weight. Examples of these monomers are acrylic acid, methacrylic acid, styrenesulfonic acid, 2-acrylamido-2-methylpropanesulfonic acid and vinylphosphonic acid, and also cationogenic monomers, such as dimethylaminoethyl acrylate, dimethylaminopropyl-methacrylamide, dimethylaminopropylacrylamide or 1-vinylimidazole, and also N-vinylformamide, acrylonitrile, methacrylonitrile, acrylamide, methacrylamide and N-vinylpyrrolidone. The basic monomers are used in the polymerization in the form of the free bases, as salt or in quaternized form. The monomers exhibiting acid groups can be used in the polymerization in the form of the free acids or in the form partially or completely neutralized with alkali metal bases or ammonium bases.

Suitable examples of monomers from group (b) are 2- and 4-methylstyrene, p-(tert-butyl)styrene, esters of ethylenically unsaturated C₃- to C₅-carboxylic acids and alcohols with more than 12 carbon atoms in the molecule, vinyl laurate, vinyl stearate and macromonomers, such as oligopropenyl acrylate.

Examples of monomers from group (c) are glycol diacrylate, allyl acrylate, allyl methacrylate, trimethylolpropane triacrylate, trimethylolpropane trimethacrylate, pentaerythritol triacrylate, pentaerythritol tetraacrylate, butanediol diacrylate, divinylbenzene, divinylurea and methylenebisacrylamide.

Thus, use may be made, for the preparation of the polymer matrix of the dispersed polymer particles, for example, of a combination of
(a) methyl methacrylate, styrene, vinyl acetate, methyl acrylate, ethyl acrylate, ethyl methacrylate, n-butyl acrylate, isobutyl acrylate, tert-butyl acrylate, acrylic acid, methacrylic acid, acrylamide, methacrylamide, acrylonitrile and/or methacrylonitrile,
(b) if appropriate, lauryl acrylate, palmityl acrylate and/or stearyl acrylate, and
(c) if appropriate, butanediol diacrylate, allyl acrylate, allyl methacrylate, divinylbenzene, trimethylolpropane triacrylate, pentaerythritol triacrylate and/or pentaerythritol tetraacrylate.

Use is preferably made, in the process according to the invention, of at least one monomer from groups (a), (b) and (c). An additional monomer combination which is preferably suitable for the preparation of the polymer matrix consists of a combination of
(a) methyl methacrylate, ethyl methacrylate and/or acrylic acid,
and
(c) butanediol diacrylate, pentaerythritol tetraacrylate, pentaerythritol triacrylate, trimethylolpropane triacrylate, allyl methacrylate and/or allyl acrylate.

According to the process according to the invention, aqueous polymer dispersions comprising at least one active substance with a mean particle size of the dispersed polymer particles of <1000 nm are obtained by miniemulsion polymerization of ethylenically unsaturated monomers. In this connection, the procedure is preferably such that first at least one active substance is dissolved in at least one monomer. The active substances are in most cases monomolecularly dissolved; however, they can also be present dissolved in the form of a colloidal dispersion. The monomer solutions comprising active substances are then emulsified in water in the presence of at least one surface-active agent. It is also possible, in place of or in addition to a surface-active agent, to use microparticles or nanoparticles which are insoluble in water and/or the monomers as stabilizers for the emulsion (Pickering effect). Stabilizers of this kind are, e.g. nanoscale silicon dioxide, aluminum oxide and magnesium sulfate. A miniemulsion with a mean droplet size of emulsified droplets of <500 nm is obtained.

The emulsification takes place according to methods which are described in detail in WO-A-99/40123, page 26, line 11 to page 32, line 4. For example, use is made, for the emulsification, of high pressure homogenizers of various models or ultrasound is allowed to act on a macroemulsion comprising, as essential constituents, at least one active substance, preferably dissolved in at least one monomer, and water, cf. EP-A-0 765 896, EP-A-1 008 380. In most cases, the mixture is emulsified in the presence of a surface-active agent. However, it is also possible to add the active substances to the miniemulsion or to add them during the preparation of the miniemulsion. However, they are preferably, as described above, first dissolved in at least one monomer and, in dissolved form or in the form of a dissolved colloidal dispersion, emulsified in water.

The aqueous phase used for the preparation of the miniemulsions consists of water and comprises, if appropriate, a surface-active agent which stabilizes the finely divided monomer droplets formed in the emulsion of the organic phase in the aqueous phase. The surface-active agent is used, for example, in amounts of up to 15% by weight, for example of 0.05 to 15% by weight, preferably of 0.05 to 5% by weight, and in particular of 0.1 to 2% by weight, in each case with reference to the entire dispersion. It is found either in the aqueous phase, the organic phase or both phases. It is preferably added to the aqueous phase before the emulsification. All surface-active agents can in principle be used. Surface-active agents which are preferably used are anionic compounds and amphiphilic copolymers with a mean molar mass M_{w} of 100 to 100 000. Examples of suitable surface-active agents are sodium lauryl sulfate, sodium dodecyl sulfate, sodium hexadecyl sulfate, sodium dioctyl sulfosuccinate and/or addition products of 15 to 50 mol of ethylene oxide and/or propylene oxide with 1 mol of C₁₂- to C₂₂-alcohol.

The miniemulsion can also, in addition, be stabilized using amphiphilic polymers which, if appropriate, are used. If amphiphilic polymers are used, they are used in amounts of, for example, 0.05 to 15% by weight, preferably 0.5 to 5% by weight, with reference to the monomers used in the polymerization. Examples of amphiphilic polymers are copolymers comprising units of
(a) hydrophobic monoethylenically unsaturated monomers and
(b) monoethylenically unsaturated carboxylic acids, monoethylenically unsaturated sulfonic acids, monoethylenically unsaturated phosphonic acids or their mixtures and/or basic monomers.

Suitable hydrophobic monoethylenically unsaturated monomers
(a) are, for example, styrene, methylstyrene, ethylstyrene, acrylonitrile, methacrylonitrile, C₂- to C₁₈-olefins, esters of monoethylenically unsaturated C₃- to C₅-carboxylic acids and monovalent alcohols, vinyl alkyl ethers, vinyl esters or their mixtures. Use is preferably made, from this group of monomers, of isobutene, diisobutene, styrene and acrylic esters, such as ethyl acrylate, isopropyl acrylate, n-butyl acrylate and sec-butyl acrylate.

The amphiphilic copolymers comprise, as hydrophilic monomers,
(b) preferably acrylic acid, methacrylic acid, maleic acid, maleic anhydride, itaconic acid, vinylsulfonic acid, 2-acrylamidomethylpropanesulfonic acid, 3-acrylamido-propanesulfonic acid, 3-sulfopropyl acrylate, 3-sulfopropyl methacrylate, styrenesulfonic acid, vinylphosphonic acid or their mixtures in copolymerized form. The acid monomers can be present in the form of the free acids or in partially or completely neutralized form.

Additional suitable hydrophilic monomers are basic monomers. They can be polymerized with the hydrophobic monomers (a) alone or also in a mixture with the abovementioned acidic monomers. If mixtures of basic and acidic monomers are used, amphoteric copolymers are produced which are anionically or cationically charged, depending on the molar ratio of the acidic to basic monomers copolymerized each time.

Basic monomers are, for example, di(C₁ to C₂)alkylamino(C₂ to C₄)alkyl (meth)acrylates or diallyldimethylammonium chloride. The basic monomers can be present in the form of the free bases, of the salts with organic or inorganic acids or in the form quaternized with alkyl halides. The salt formation or the quaternization, in which the basic monomers become cationic, can be carried out partially or completely. Examples of such compounds are dimethylaminoethyl methacrylate, diethylaminoethyl methacrylate, dimethylaminoethyl acrylate, diethylaminoethyl acrylate, dimethylaminopropyl methacrylate, dimethylaminopropyl acrylate, diethylaminopropyl methacrylate, diethylaminopropyl acrylate and/or dimethylaminoethylacrylamide, dimethylaminoethylmethacrylamide, dimethylaminopropylacrylamide, dimethylaminopropylmethacrylamide and/or diallyldimethylammonium chloride.

If the amphiphilic copolymers in the form of the free acid are not sufficiently soluble in water, they are used in the form of water-soluble salts, e.g. the corresponding alkali metal, alkaline earth metal and ammonium salts are used. These salts are prepared, for example, by partial or complete neutralization of the free acid groups of the amphiphilic copolymers with bases, e.g. sodium hydroxide solution, potassium hydroxide solution, magnesium oxide, ammonia or amines, such as triethanolamine, ethanolamine, morpholine, triethylamine or butylamine, are used for the neutralization. The acid groups of the amphiphilic copolymers are preferably neutralized with ammonia or potassium hydroxide solution. The solubility in water of basic monomers or of copolymers comprising such monomers copolymerized can, on the other hand, be increased by partial or complete neutralization with an inorganic acid, such as hydrochloric acid or sulfuric acid, or by addition of an organic acid, such as acetic acid or p-toluenesulfonic acid. The molar mass of the amphiphilic copolymers is, for example, 1000 to 100 000 and preferably ranges from 1500 to 10 000. The acid numbers of the amphiphilic copolymers are, for example, 50 to 500, preferably 150 to 350, mg of KOH/g of polymer.

Particular preference is given to those amphiphilic copolymers comprising, copolymerized:
(a) 95 to 45% by weight of isobutene, diisobutene, styrene or their mixtures, and
(b) 5 to 55% by weight of acrylic acid, methacrylic acid, maleic acid, maleic acid hemiester or their mixtures.

Particular preference is given to the use, as stabilizer for the miniemulsion, of copolymers comprising, copolymerized:
(a) 45 to 80% by weight of styrene,
(b) 55 to 20% by weight of acrylic acid and, if appropriate,
(c) additional monomers also.

The copolymers can, if appropriate, comprise units of maleic acid hemiesters copolymerized as additional monomers (c). Such copolymers can, for example, be obtained by preparing copolymers of styrene, diisobutene or isobutene or their mixtures with maleic anhydride in the absence of water and, subsequent to the polymerization, by reacting the copolymers with alcohols, using 5 to 50 mol % of a monovalent alcohol per mole of anhydride groups in the copolymer. Suitable alcohols are, for example, methanol, ethanol, n-propanol, isopropanol, n-butanol, isobutanol and tert-butanol. However, it is also possible to react the anhydride groups of the copolymers with polyvalent alcohols, such as glycol or glycerol. In this connection, however, the reaction is taken only so far that only one OH group of the polyvalent alcohol reacts with the anhydride group. If the anhydride groups of the copolymers are not completely reacted with alcohols, the anhydride groups which have not reacted with alcohols are ring-opened by the addition of water.

Other compounds suitable as stabilizer for miniemulsions are, for example, commercial polymers of monoethylenically unsaturated acids and graft polymers of N-vinylformamide on polyalkylene glycols described, for example in WO-A-96/34903. If appropriate, up to 10% of the grafted vinylformamide units can be hydrolyzed. The proportion of grafted vinylformamide units is preferably 20 to 40% by weight, with reference to polyalkylene glycol. Use is preferably made of polyethylene glycols with molar masses of 2000 to 10 000.

In addition, the zwitterionic polyalkylenepolyamines and zwitterionic polyethyleneimines are suitable for stabilizing miniemulsions. Such compounds are, for example, known from EP-B-0 112 592. They can, for example, be obtained by first alkoxylating a polyalkylenepolyamine or polyethyleneimine, e.g. with ethylene oxide, propylene oxide and/or butylene oxide, and by subsequently quaternizing the alkoxylation products, e.g. with methyl bromide or dimethyl sulfate, and by then sulfating the quaternized alkoxylated products with chlorosulfonic acid or sulfur trioxide. The molar mass of the zwitterionic polyalkylenepolyamines is, for example, 1000 to 9000, preferably 1500 to 7500. The zwitterionic polyethyleneimines preferably have molar masses in the range from 1500 to 7500 daltons. The other abovementioned stabilizers are, if appropriate, used in addition to a surface-active agent for stabilizing the miniemulsion. If they are used, they are used, for example, in amounts of 0.05 to 15% by weight, preferably 0.5 to 5% by weight, with reference to the monomers.

In order to stabilize a miniemulsion, use is additionally made, in the preparation of these emulsions, if appropriate, of a nonpolymerizable hydrophobic compound, e.g. a hydrocarbon (e.g. an aliphatic or aromatic hydrocarbon (e.g. hexadecane)), an alcohol with 10 to 24 carbon atoms, hydrophobic polymers with molar masses M_{w}<100 000, tetraalkylsilanes and/or mixtures of the abovementioned compounds. Examples of such stabilizers are hexadecane, decahydronaphthalene, olive oil, polystyrene with an average molar mass M_{w} of 500 to 50 000, siloxanes with a molar mass M_{w} of 500 to 5000, poly(n-butyl acrylate), such as Acronal® A 150 F or PnBA (a high-pressure temperature solution polymer of n-butyl acrylate (120° C. in isopropanol) with a K value of 24 determined in isopropanol at 25° C.), homopolymers of ethylene, propylene, 1-butene, 2-butene, 1-pentene or 1-hexene with an average molar mass M_{w} of 100 to 10 000, copolymers with an average molar mass of 100 to 10 000 of at least two of the abovementioned olefins and/or polyisobutylene with an average molar mass M_{w} of at least 100, in particular of 400 to 10 000, cetyl alcohol, stearyl alcohol, palmityl alcohol and/or behenyl alcohol. Additional possible hydrophobic nonpolymerizable compounds are film-forming assistants or plasticizers, such as Plastilit® 3060 from BASF (an industrial mixture of the di(n-butyl) esters of C₄-C₆-dicarboxylic acids), furthermore resins, such as rosin resins (cf. Ullmanns Encycl. Techn. Chem., 4th edition (1976), Vol. 12, pages 525-538) and hydrocarbon resins (cf. Encycl. Polym. Sci. Eng., (1987) Vol. 7, pages 758-782), such as, e.g., Cristalex F 85 from Hercules. Mention may be made, by way of example, of Foral® 85 E, a glycerol ester of highly hydrogenated rosin resin (softening point: 86° C.) from Hercules. The hydrophobic nonpolymerizable compounds are optionally used. They have a solubility in water of <0.1 g/l at 25° C. and 1 bar. If they are used, they are used in amounts of 1 to 10, preferably 2 to 6% by weight, with reference to the monomers used in the polymerization.

The K value is a relative viscosity number determined analogously to DIN 53726. It comprises the flow rate of the pure solvent relative to the flow rate of the 0.1% by weight solution of the polymer in the same solvent (cf. also Cellulosechemie, Vol. 13 (1932), pages 58-64, and Kirk-Othmer Encyclopedia of Chemical Technology, Vol. 23, pages 967-968). The K value is a measurement for the average molecular weight of a polymer. A high K value corresponds in this connection to a high average molecular weight.

In order to obtain stable aqueous polymer dispersions, it is additionally possible, if appropriate, to carry out the polymerization in the presence of protective colloids. They generally have average molar masses M_{w} of greater than 500, preferably of more than 1000. Examples of protective colloids are polyvinyl alcohols, cellulose derivatives, such as carboxymethylcellulose, polyvinylpyrrolidone, polyethylene glycols, graft polymers of vinyl acetate and/or vinyl propionate on polyethylene glycols, polyethylene glycols closed at one or both ends with alkyl, carboxyl or amino groups, polydiallyldimethylammonium chlorides and/or polysaccharides, such as, in particular, water soluble starches, starch derivatives and proteins. Such products are described, for example, in Römpp, Chemie Lexikon, 9th edition, volume 5, page 3569, or in Houben-Weyl, Methoden der organischen Chemie, 4th edition, volume 14/2, chapter IV, Umwandlung von Cellulose und Stärke [Conversion of Celluloses and Starches] by E. Husemann and R. Werner, pages 862-915 and in Ullmann's Encyclopedia of Industrial Chemistry, 6th edition, volume 28, pages 533 ff, under Polysaccharides.

All types of starch, e.g. both amylose and amylopectin, native starches, hydrophobically or hydrophilically modified starches, anionic starches, cationically modified starches, degraded starches, the starch breakdown being able to be carried out, for example, oxidatively, thermally, hydrolytically or enzymatically, and both native and modified starches being able to be used for the starch breakdown, are suitable, for example. Additional suitable protective colloids are dextrins and crosslinked water-soluble starches which are swellable in water.

Use is preferably made, as protective colloid, of native water-soluble starches which can be converted into water-soluble form, for example by starch decomposition, and also anionically modified starches, such as oxidized potato starch. Particular preference is given to anionically modified starches which have been subjected to a reduction in molecular weight. The reduction in molecular weight is preferably carried out enzymatically. The average molar mass M_{w} of the degraded starches is, for example, 500 to 100 000, preferably 1000 to 30 000. The degraded starches have, for example an intrinsic viscosity [η] of 0.04 to 0.5 gl/g. Such starches are, for example, described in EP-B-0 257 412 and in EP-B-0 276 770. If protective colloids are used in the polymerization, the amounts used are, for example, 0.5 to 50, in particular 5 to 40% by weight, usually 10 to 30% by weight, with reference to the monomers used in the polymerization.

In order to modify the properties of the polymers, it is possible, if appropriate, to carry out the polymerization in the presence of at least one polymerization regulator. Examples of polymerization regulators are organic compounds comprising sulfur in bonded form, such as dodecyl mercaptan, thiodiglycol, ethylthioethanol, di(n-butyl) sulfide, di(n-octyl) sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea, aldehydes, such as formaldehyde, acetaldehyde and propionaldehyde, organic acids, such as formic acid, sodium formate or ammonium formate, alcohols, such as isopropanol in particular, and phosphorus compounds, such as sodium hypophosphite. If a regulator is used in the polymerization, the amount used each time is thus, for example, 0.01 to 5, preferably 0.1 to 1, % by weight, with reference to the monomers used in the polymerization. Polymerization regulators and crosslinking agents can be used in the polymerization independently of one another or together. It is accordingly possible, for example, to control the rheology of the polymer dispersions being produced.

The miniemulsion is polymerized under radical conditions. The polymerization is generally carried out in the presence of at least one radical polymerization initiator. All compounds which can trigger a polymerization are suitable as polymerization initiator. In this connection, they are essentially peroxides, hydroperoxides, azo compounds and redox catalysts. Examples of initiators can be taken from WO-A-99/40123, page 32, line 45, to page 34, line 9. The polymerization can also be triggered by the action of high-energy radiation, such as UV or actinic or radioactive radiation, the operation being carried out, if appropriate, in the presence of at least one sensitizer. The polymerization of the monomers in the miniemulsion can also be carried out electrochemically, using microwave radiation and/or by the action of ultrasound. The polymerization temperature is, for example, 0 to 120° C., the polymerization being carried out at temperatures of greater than 100° C. under elevated pressure in pressure-tight devices. The miniemulsion is usually polymerized in the temperature range from 0 to 95° C. The polymerization of the monomers of the miniemulsion can be carried out according to all known polymerization processes. They can, e.g., be carried out in a single-stage or also in a two- or multistage process.

The polymerization can, for example, also be carried out so that, first, only at most 50% of the monomers polymerize which are present in the polymerization region. If, during the polymerization, the active substances are incompatible with the polymer being formed, i.e. the active substances are insoluble in the polymer being produced or the mixture of monomer and the polymer being formed, it may happen that the active substances collect in the core of the polymer particle being formed and are covered by a shell of a polymer. It is then simply necessary to give the polymerizing system sufficient time for a separation of the active substances to be able to occur. The polymerization is then taken to completion only after extensive or complete accumulation of active substances in the core of the polymer particles being produced. The separation of active substance and the polymer being formed can be monitored using samples withdrawn during the polymerization. However, the active substances can also, as a function of the polymerization conditions, if appropriate, partially enter the aqueous phase, form domains in the polymer particle, migrate to the surface of the polymer particles or be concentrated or even uniformly distributed elsewhere in the polymer.

However, the polymerization of the miniemulsion can also be carried out in a single stage by, e.g. introducing 5 to 30% of the miniemulsion to be polymerized, starting the polymerization and metering in the remaining miniemulsion continuously or portionwise under polymerization conditions. However, it is also possible to introduce smaller amounts of a miniemulsion into a polymerization region and to continuously add and polymerize the remaining miniemulsion under polymerization conditions.

The polymerization can also be carried out in at least two stages. For this, a miniemulsion comprising at least one active substance is first prepared from
(a) at least one ethylenically unsaturated monomer A with a solubility in water of >0.01 g/l (at 25° C. and 1013 mbar),
(b) if appropriate at least one ethylenically unsaturated monomer B with a solubility in water of <0.01 g/l (at 25° C. and 1013 mbar) and
(c) if appropriate at least one ethylenically unsaturated monomer C with at least two double bonds,
   and at least one surface-active agent and, if appropriate, at least one hydrophobic compound, for example decahydronaphthalene or polyisobutylene, it also being possible to add the active substances during the emulsifying operation or subsequently to the miniemulsion, the monomers of the miniemulsion are then polymerized up to a conversion of at most 50%, an aqueous macroemulsion of at least one ethylenically unsaturated monomer (c) with at least two double bonds in the molecule is subsequently metered in and the polymerization is taken to completion.

However, usually, the starting material is a solution of at least one active substance in at least one monomer which is first emulsified in water in the presence of at least one surface-active agent to give a miniemulsion. The monomers of the miniemulsion are subsequently polymerized up to a conversion of at most 35%, an aqueous macroemulsion of at least one ethylenically unsaturated monomer (c) with at least two double bonds in the molecule is subsequently added under polymerization conditions and the polymerization of the remaining monomers is taken to completion, either simultaneously with the metering in of the monomer (c) or subsequently.

However, the polymerization can also be carried out in a single stage by, e.g. introducing a portion of the miniemulsion, starting the polymerization and metering in the remaining miniemulsion continuously or portionwise under polymerization conditions.

In another embodiment of the invention, a polymerization initiator sufficient for the initiation of at most 25% of the monomers initially introduced is added to a mixture, heated to polymerization temperature, of an initially introduced miniemulsion of the monomers (a) and, if appropriate, (b) comprising at least one active substance, the remaining amounts of this miniemulsion and an aqueous mixture of at least one monomer (c) are added and, depending upon the consumption by polymerization of the initiator added, additional polymerization initiator is metered in, in order to polymerize the remaining monomers.

The crosslinking agents according to (c) which can optionally be used are either metered in bulk, it being possible for the metering to be carried out all at once entirely at the beginning in the receptacle—before the actual polymerization begins—or also in the feed process. If at least two crosslinking agents are used, these can be metered in either as a mixture or separately from one another, at the same time or with a gap in time. The crosslinking agents can also be introduced into the miniemulsion together with the monomers. However, they can also be emulsified in water and be metered in altogether as emulsion feed or in a feed operation together with the miniemulsion. In this connection, it is advantageous for at least one surfactant to guarantee the stability of the crosslinking agent emulsion.

Use is preferably made, as oil phase for the miniemulsion, of
(a) methyl methacrylate, styrene, vinyl acetate, methyl acrylate, ethyl methacrylate, acrylic acid and/or methacrylic acid,
(b) stearyl acrylate, lauryl acrylate and/or palmityl acrylate
and
(c) butanediol diacrylate, pentaerythritol tetraacrylate, pentaerythritol triacrylate, allyl acrylate, allyl methacrylate, divinylbenzene and/or trimethylolpropane triacrylate.

Aqueous polymer dispersions comprising active substances are obtained. The solids concentration of these aqueous dispersions is, for example, 10 to 60, preferably 20 to 45, % by weight. The aqueous polymer dispersions comprise dispersed particles with an average particle size <1000 nm, usually <500 nm, for example 5 to 450 nm, preferably 10 to 300 nm and in particular 50 to 250 nm. The polymer particles consist essentially of a polymer matrix and comprise at least one pesticide as active substance in an amount of 0.5 to 60% by weight. This amount corresponds in general to the amounts used in the oil phase of the miniemulsion since the processes described above result in at least 80% by weight, preferably at least 90% by weight, particularly preferably at least 95% by weight of the active substance used being copolymerized in the polymer particles obtained.

The pesticide can, as already described above, for example be homogeneously distributed in the polymer matrix or be present in the form of domains in the polymer particle. However, the dispersed particles can also be formed from a core and a shell, the core of the particles comprising at least one pesticide covered by a shell of a polymer matrix. However, the pesticide can also emerge partially or almost completely from the polymer matrix. It is then present in the form of particles with an average size of ca. 40 to 400 nm which are stabilized with surfactants in the aqueous phase.

Polymer powders comprising at least one pesticide as active substance can be obtained from the aqueous dispersions prepared according to the process according to the invention by evaporating the volatile constituents of an aqueous polymer dispersion comprising at least one pesticide. The dispersions prepared according to the invention and the polymer powders obtained therefrom have the advantage that they release the active substances in a controlled fashion and protect from decomposition, i.e. active substances are given off continuously over a relatively long period of time and are largely protected from external influences. The pesticides are accordingly present in a matrix which is particularly advantageous for their application.

The polymer powders comprising at least one pesticide as active substance obtained, e.g. by spray drying, from the aqueous dispersions prepared according to the invention, for example, are of industrial interest. According to another embodiment of the invention, use is made of an aqueous dispersion for plant protection which can be obtained by polymerizing a miniemulsion comprising at least one pesticide.

The pesticide-comprising aqueous dispersions prepared according to the invention and the polymer powders comprising at least one pesticide obtainable therefrom by removal of the aqueous phase are preferably used in pesticide formulations. The term “pesticide formulation” is illustrated further below. The invention accordingly also relates to the use of the dispersions prepared according to the process according to the invention for combating harmful microorganisms and/or for regulating the growth of plants and/or for combating undesirable plant growth and/or for combating undesirable insect or acarid infestation on plants and/or for combating phytopathogenic fungi and/or for seed treatment.

The process for combating harmful microorganisms and/or for regulating the growth of plants and/or for combating undesirable insect or acarid infestation on plants and/or for combating phytopathogenic fungi and/or for seed treatment comprises treating the undesirable microorganisms, phytopathogenic fungi/insects or acarids, their habitat or the plants, the soil or seeds of useful plants to be protected from microorganisms, fungal infestation or insect infestation with an effective amount of a pesticide formulation comprising a dispersion prepared according to the process according to the invention or polymer powders obtainable therefrom by removing the aqueous phase.

The process for combating undesirable plant growth comprises treating plants, the soil on which the plants are growing or seed with an effective amount of a pesticide formulation comprising a dispersion prepared according to the process according to the invention or polymer powders obtainable therefrom by removing the aqueous phase.

Combating undesirable plant growth means the combating/destruction of plants which grow in places where they are undesirable, e.g. of dicotyledonous plants of the following types: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum;

Monocotyledonous plants of the following types: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, Ischaemum, Sphenoclea, Dactyloctenium, Agrostis, Alopecurus, Apera.

The term “undesirable insect or acarid” describes but is not limited to the following kinds:

Lepidoptera, for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Chematobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis;
beetles (Coleoptera), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria;
Diptera, for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia irritans, Haplodiplosis equestris, Hylemyia platura, Hypoderma lineata, Liriomyza sativae, Liriomyza trifolii, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa;
Thysanoptera, for example Frankliniella fusca, Frankliniella occidentalis, Frankliniella tritici, Scirtothrips citri, Thrips oryzae, Thrips palmi and Thrips tabaci;
Hymenoptera, for example Athalia rosae, Atta cephalotes, Atta sexdens, Atta texana, Hoplocampa minuta, Hoplocampa testudinea, Monomorium pharaonis, Solenopsis geminata and Solenopsis invicta;
Heteroptera, for example Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis and Thyanta perditor;
Homoptera, for example Acyrthosiphon onobrychis, Adelges laricis, Aphidula nasturtii, Aphis fiabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantii and Viteus vitifolii;
Termites (Isoptera), e.g. Calotermes flavicollis, Leucotermes flavipes, Reticulitermes lucifugus and Termes natalensis;
Orthoptera, e.g. Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus;
Arachnoidea, for example Acarina, e.g. from the Argasidae, Ixodidae and Sarcoptidae families, e.g. Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp. e.g. Aculus schlechtendali, Phyllocoptrata oleivora and Eriophyes sheldoni; Tarsonemidae spp. e.g. Phytonemus pallidus and Polyphagotarsonemus latus; Tenuipalpidae spp. e.g. Brevipalpus phoenicis; Tetranychidae spp. e.g. Tetranychus cinnabarinus, Tetranychus kanzawai, Tetranychus pacificus, Tetranychus telarius and Tetranychus urticae, Panonychus ulmi, Panonychus citri and Oligonychus pratensis;
Nematodes, in particular nematodes which parasitize plants, e.g. plant root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; seed gall nematodes, Anguina species; stem and foliar nematodes, Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, Mesocriconema species; stem and bulb nematodes, Ditylenchus destructor, Ditylenchus dipsaci and other Ditylenchus species; awl nematodes, Dolichodorus species; spiral nematodes, Heliocotylenchus multicinctus and other Helicotylenchus species; sheath and sheathoid nematodes, Hemicycliophora species and Hemicriconemoides species; Hirshmanniella species; lance nematodes, Hoploaimus species; false rootknot nematodes, Nacobbus species; needle nematodes, Longidorus elongatus and other Longidorus species; lesion nematodes, Pratylenchus neglectus, Pratylenchus penetrans, Pratylenchus curvitatus, Pratylenchus goodeyi and other Pratylenchus species; burrowing nematodes, Radopholus similis and other Radopholus species; Reniform nematodes, Rotylenchus robustus and other Rotylenchus species; Scutellonema species; stubby root nematodes, Trichodorus primitivus and other Trichodorus species, Paratrichodorus species; stunt nematodes, Tylenchorhynchus claytoni, Tylenchorhynchus dubius and other Tylenchorhynchus species; citrus nematodes, Tylenchulus species; dagger nematodes, Xiphinema species; and rice pathogens, such as, i.e., rice water weevil (Lissorhoptrus oryzaphilus), rice stem borer (Chilo suppresalis), rice leaf roller, rice leaf beetle, rice leaf miner (Agromyca oryzae), leafhoppers (Nephotettix spp.; especially smaller brown leafhopper, green rice leafhopper), planthoppers (Delphacidae; especially white backed planthopper, brown rice planthopper), stinkbugs.

The term “phytopathogenic fungi” describes but is not limited to the following species:

Blumeria graminis (powdery mildew) on cereals, Erysiphe cichoracearum and Sphaerotheca fuliginea on cucurbits, Podosphaera leucotricha on apples, Uncinula necator on grape vines, Puccinia species on cereals, Rhizoctonia species on cotton, rice and lawns, Ustilago species on cereals and sugar cane, Venturia inaequalis on apples, Bipolaris and Drechslera species on cereals, rice and lawns, Septoria nodorum on wheat, Botrytis cinerea on strawberries, vegetables, ornamental plants and grape vines. Mycosphaerella species on bananas, peanuts and cereals, Pseudocercosporella herpotrichoides on wheat and barley, Pyricularia oryzae on rice, Phytophthora infestans on potatoes and tomatoes, Pseudoperonospora species on cucurbits and hops, Plasmopara viticola on grape vines, Alternaria species on fruit and vegetables, and also Fusarium and Verticillium species, Bipolaris and Drechslera species and also Pyricularia oryzae, Corticium sasakii (syn. Rhizoctonia solani) and Cochliobolus miyabeanus on rice plants and, if appropriate, on their seeds, Paecilomyces variotii on materials such as wood.

It is possible, using the pesticides present in the polymers of the aqueous dispersions prepared according to the invention, to control undesirable plant growth and/or to combat phytopathogenic insects and/or phytopathogenic fungi.

Pesticide formulations comprising pesticide-comprising aqueous polymer dispersions obtainable according to the process according to the invention or polymer powders which have been prepared from the dispersion prepared according to the process according to the invention by removing the aqueous phase, as already mentioned above, are an additional subject matter of the present invention.

The pesticide-comprising aqueous polymer dispersions obtainable according to the process according to the invention can either be used directly or optionally comprise additional auxiliaries suitable for the formulation, such as, e.g., surface-active agents (such as wetting agents, stickers, emulsifiers or dispersants), foam prevention agents, thickeners, carriers, antifreeze agents and bactericides.

The polymer powders obtainable from the dispersions prepared according to the process according to the invention can either be used directly or optionally comprise additional auxiliaries suitable for the formulation (e.g. surface-active agents (such as wetting agents, stickers, emulsifiers or dispersants), foam prevention agents, thickeners, carriers, antifreeze agents and bactericides) and, if appropriate, solvents.

The significance and corresponding use of the abovementioned agents depend on the formulation type desired and on the nature of the active substance.

If carriers are used, in particular in solid formulations, they are thus usually present in the formulations in an amount of 0.1 to 99% by weight, preferably of 10 to 80% by weight. The amount of the other auxiliaries in the formulations is, if they are used, for example 0.1 to 40% by weight.

If solvents are used, water, aromatic solvents (e.g. Solvesso® products, xylene), paraffin hydrocarbons (e.g. petroleum fractions), alcohols (e.g. methanol, butanol, pentanol, benzyl alcohol), ketones (e.g. cyclohexanone, γ-butyrolactone), pyrrolidones (NMP, NOP), acetates (glycol diacetate), glycols, fatty acid dimethylamides, fatty acids and fatty acid esters are suitable, for example. Solvent mixtures can also in principle be used.

Examples of thickeners (i.e. compounds which bestow a pseudoplastic flow behavior on the formulation, i.e. high viscosity at rest and low viscosity in the agitated state) are, for example, polysaccharides, such as xanthan gum (Keizan® from Kelco), Rhodopol® 23 (Rhone-Poulenc) or Veegum® (R.T. Vanderbilt) or inorganic layered minerals, such as Attagel® (Engelhardt).

Silicone emulsions (e.g., Silikon® SRE, Wacker, or Rhodorsil® from Rhodia), long-chain alcohols, fatty acids, fluoroorganic compounds and their mixtures, for example, are suitable as antifoaming agents.

Bactericides can, for example, be used to stabilize aqueous pesticide formulations. Suitable bactericides are, for example, Proxel® from ICI or Acticide® RS from Thor Chemie and Kathon® MK from Rohm & Haas.

Suitable antifreeze agents are, e.g., ethylene glycol, propylene glycol or glycerol.

Examples of carriers are ground natural minerals (e.g. kaolins, clays, talc, chalk) and ground synthetic minerals (e.g. highly dispersed silica, silicates).

Examples of surface-active agents are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers; also condensation products of sulfonated naphthalene and naphthalene derivatives with formaldehyde, condensation products of naphthalene or of naphthalenesulfonic acid with phenol and formaldehyde, polyoxyethylene fatty alcohol ethers, such as polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Examples of formulation types which can be prepared on the basis of the polymer powders or of the dispersions according to the invention are suspensions, dispersible concentrates, pastes, pellets, wettable powders, dustable powders (DP) or granules (GR, FG, GG, MG) which can be either soluble or dispersible in water. Standard formulation types for seed treatment are FS (flowable concentrates), DS (powders for dry treatment), WS (water dispersible powders for slurry treatment), SS (water-soluble powders SS). The preparation of these formulations and the technology necessary therefor are known to a person skilled in the art (cf. U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pp. 8-57 and ff., WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2 095 558, U.S. Pat. No. 3,299,566, Klingman, Weed Control as a Science, John Wiley and Sons Inc., New York, 1961, Hance et al., Weed Control Handbook, 8th Ed., Blackwell Scientific Publications, Oxford, 1989 and Mollet, H., Grubemann, A., Formulation Technology, Wiley VCH Verlag GmbH, Weinheim (Federal Republic of Germany), 2001), D. A. Knowles, Chemistry and Technology of Agrochemical Formulations, Kluwer Academic Publishers, Dordrecht, 1998 (ISBN 0-7514-0443-8).

Granules are, for example, finely milled and combined with 95.5% of carriers. Standard processes in this connection are extrusion, spray drying or fluid bed. A granule for direct application is thereby obtained.

Petroleum fractions having medium to high boiling points, such as kerosene or diesel oil, furthermore coal tar oils, and oils of vegetable or animal origin, aliphatic, cyclic and aromatic hydrocarbons, e.g. toluene, xylene, paraffin, tetrahydronaphthalene, alkylated naphthalenes or derivatives thereof, methanol, ethanol, propanol, butanol, cyclohexanol, cyclohexanone, isophorone or highly polar solvents, e.g. dimethyl sulfoxide, N-methylpyrrolidone or water, are suitable for the preparation of directly sprayable liquids, emulsions, pastes or oil dispersions.

Powders, preparations for broadcasting and dusts can be prepared by mixing or mutually grinding the aqueous polymer dispersions comprising active substances or the powders which can be obtained therefrom, for example by spray drying, with a solid carrier.

Granules, e.g. coated granules, impregnated granules and homogeneous granules, can be prepared by binding the products prepared according to the invention to solid carriers. Solid carriers are, e.g., mineral earths, such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate or ureas, and plant products, such as cereal meal, tree bark meal, wood meal and nutshell meal, cellulose powders and other solid carriers. If required, the final product obtained can be dried before additional processing.

The present invention also comprises seeds which have been treated with a pesticide formulation according to the invention.

The term “seed treatment” comprises all common techniques (seed dressing, seed coating, seed dusting, seed soaking, seed film coating, seed multilayer coating, seed encrusting, seed dripping and seed pelleting).

The term “seed” comprises seeds of all kinds, such as, e.g., grains, seeds, fruit, tubers, cuttings and similar forms. In this connection, the term “seed” preferably describes grains and seeds.

Suitable as seed are cereal seeds, grain crop seeds, root crop seeds, oleaginous seeds, vegetable seeds, spice seeds or ornamental plant seeds, e.g. seed of wheat, including hard wheat, barley, oats, rye, corn (fodder corn and sweetcorn), soybean, oleaginous plants, crucifers, cotton, sunflowers, bananas, rice, rape, turnips, sugar beet, fodder beet, eggplants, potatoes, grass, lawns, fodder grass, tomatoes, leek, pumpkin, cabbage, iceberg lettuce, pepper, cucumbers, melons, Brassica spp., beans, peas, garlic, onions, carrots, tuberous plants, such as sugar cane, tobacco, grapes, petunias and geraniums, pansies, touch-me-not, preferably wheat, corn, soybean and rice.

The seed of transgenic plants or of plants obtained by conventional breeding methods can also be used as seed.

Thus, use may be made of seed which is tolerant to herbicides, fungicides or insecticides, e.g. to sulfonylureas (e.g. EP-A-0 257 993, U.S. Pat. No. 5,013,659), imidazolinones (e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), glufosinate-type herbicides (e.g. EP-A-0 242 236, EP-A-242 246) or glyphosate-type herbicides (e.g. WO 92/00377) or herbicides of the category of the cyclohexadienones/aryloxyphenoxypropionic acids (e.g. U.S. Pat. No. 5,162,602, U.S. Pat. No. 5,290,696, U.S. Pat. No. 5,498,544, U.S. Pat. No. 5,428,001, U.S. Pat. No. 6,069,298, U.S. Pat. No. 6,268,550, U.S. Pat. No. 6,146,867, U.S. Pat. No. 6,222,099, U.S. Pat. No. 6,414,222); or seed of transgenic plants, e.g. cotton, which produce Bacillus thuringiensis toxin (Bt toxins) and are thereby resistant to certain harmful organisms (e.g. EP-A-0 142 924, EP-A-0 193 259).

In addition, use may also be made of seed of plants which exhibit modified properties in comparison with conventional plants. Examples of this are modified starch synthesis (e.g. WO 92/11376, WO 92/14827, WO 91/19806) or fatty acid compositions (e.g. WO 91/13972).

Amounts of pesticides consumed of 0.1 to 10 kg/100 kg of seed, preferably 0.1 to 5 kg/100 kg, in particular 0.1 to 2.5 kg/100 kg, are generally used in the seed treatment.

### EXAMPLES

The percentage indications in the examples represent percent by weight. The droplet size of the miniemulsion was determined using a Coulter N4 Plus Particle Analyzer on 0.01% by weight samples of the emulsion. The average particle size of the dispersed polymer particles was determined using a Coulter LS 230 on 0.01% by weight samples of the aqueous dispersions.

### Example 1

30 g of the fungicide epoxiconazole were dissolved at ambient temperature in 15 minutes in a mixture of 142.5 g of methyl methacrylate and 7.5 g of stearyl acrylate.

This solution was then charged to 15 g of a 15% aqueous sodium lauryl sulfate solution and 663.56 g of completely deionized water and emulsified therein. The macro-emulsion thus prepared was subsequently brought, using ultrasound, to a droplet size of ca. 192 nm. This miniemulsion was stable on storage.

188.74 g (24% of the total amount) of the miniemulsion were introduced into a reactor and heated to 80° C. 4.5 g of a 2% aqueous solution of sodium persulfate were then added all at once at 80° C. Subsequently, 597.82 g (76% of the total amount) of the miniemulsion and, simultaneously in a separate feed, a stirred mixture (emulsion) of 15 g of water and 7.5 g of pentaerythritol tetraacrylate and 0.75 g of a 15% aqueous sodium lauryl sulfate solution were metered in, in each case in 60 minutes. The reaction mixture was subsequently stirred for a further 30 minutes at 80° C. After this time, ca. 10% of the monomers were polymerized.

In order to polymerize the remainder of the monomers, 70.5 g of a 2% aqueous solution of sodium persulfate were metered into the reaction mixture, heated to 80° C., over a period of time of 60 minutes, the mixture was subsequently stirred for a further 60 minutes at 80° C. for postpolymerization, it was then allowed to cool to 25° C. and it was filtered, first through a 500 μm and then through a 125 μm woven-wire sieve, in order to remove the coagulate.

An aqueous polymer dispersion with an average particle size of the polymer particles of 136 nm was thus obtained. As was shown by the electron micrographs of pulverulent polymer particles obtained by drying the aqueous dispersion, the particles were core/shell particles in which the fungicide epoxiconazole could be found at least partially in the shell and the polymer in the core. The dispersion was stable on storage.

### Example 2

30 g of the fungicide epoxiconazole were dissolved, at 80° C. in 15 minutes, in a mixture of 190 g of n-butyl acrylate and 10 g of stearyl acrylate.

This solution was then charged to a solution, at a temperature of 80° C., of 20 g of a 15% aqueous sodium lauryl sulfate solution and 844.7 g of completely deionized water and emulsified. The macroemulsion thus prepared was then brought to a droplet size of ca. 200 nm by passing three times through an APV Gaulin high-pressure homogenizer (150 bar) at 80° C. This miniemulsion was stable on storage for 24 h.

1098.7 g (100% of the total amount) of the miniemulsion were introduced at 80° C. into a reactor. 6 g of a 2% aqueous solution of sodium persulfate were then added all at once at 80° C. Subsequently, a stirred mixture (emulsion) of 20 g of completely deionized water and 10 g of pentaerythritol tetraacrylate and 1.0 g of a 15% aqueous sodium lauryl sulfate solution was metered in 60 minutes. The reaction mixture was subsequently stirred for a further 30 minutes at 80° C. After this time, ca. 10% of the monomers were polymerized.

In order to bring the polymerization to completion, 94 g of a 2% aqueous solution of sodium persulfate were metered into the reaction mixture, heated to 80° C., over a period of time of 60 minutes and the mixture was subsequently stirred for a further 60 minutes at 80° C. for postpolymerization. The polymerization could be brought to completion by addition of 6 g of tert-butyl hydroperoxide and an additional postreaction time. The reaction mixture was then allowed to cool to 25° C. and it was filtered, through a 500 μm and subsequently through a 125 μm woven-wire sieve, in order to remove the coagulate.

An aqueous polymer dispersion with an average particle size of the polymer particles of 134 nm was obtained. The dispersion was stable on storage.

### Example 3

32.9 g of the pulverulent fungicide triticonazole were dissolved, at 80° C. in 15 minutes, in a mixture of 190 g of methyl methacrylate and 10 g of stearyl acrylate.

This solution was then charged to a solution, at a temperature of 80° C., of 20 g of a 15% aqueous sodium lauryl sulfate solution and 841.8 g of completely deionized water and emulsified. The macroemulsion thus prepared was then brought to a droplet size of ca. 200 nm by passing three times through an APV Gaulin high-pressure homogenizer (150 bar) at 80° C. This miniemulsion was stable on storage for 24 h.

1094.7 g (100% of the total amount) of the miniemulsion were introduced at 80° C. into a reactor. 6 g of a 2% aqueous solution of sodium persulfate were then added all at once at 80° C. Subsequently, a stirred mixture (emulsion) of 20 g of completely deionized water and 10 g of pentaerythritol tetraacrylate and 1.0 g of a 15% aqueous sodium lauryl sulfate solution was metered in 60 minutes. The reaction mixture was subsequently stirred for a further 30 minutes at 80° C. After this time, ca. 10% of the monomers were polymerized.

In order to bring the polymerization to completion, 94 g of a 2% aqueous solution of sodium persulfate were metered into the reaction mixture, heated to 80° C., over a period of time of 60 minutes and the mixture was subsequently stirred for a further 60 minutes at 80° C. for postpolymerization. The polymerization could be brought to completion by addition of 8 g of tert-butyl hydroperoxide and an additional postreaction time. The reaction mixture was then allowed to cool to 25° C. and it was filtered, through a 500 μm and subsequently through a 125 μm woven-wire sieve, in order to remove the coagulate.

An aqueous polymer dispersion with an average particle size of the polymer particles of 131 nm was obtained, the polymer particles comprising virtually all the fungicide used in the polymerization. The dispersion was stable on storage.

1. A process for producing pesticide-comprising aqueous polymer dispersions with an average particle size of the dispersed particles of <1000 nm by radical polymerization of an oil-in-water emulsion, the oil phase of which comprises at least one pesticide in at least one ethylenically unsaturated monomer, which comprises emulsifying a solution of at least one pesticide in at least one monomer in water in the presence of at least one surface-active agent, to give a miniemulsion with an average droplet size <500 nm, and/or adding at least one pesticide during the emulsification or afterwards, and subsequently polymerizing the miniemulsion under radical conditions.

2. The process according to claim 1, wherein use is made, as ethylenically unsaturated monomers, of
(a) 50 to 100% by weight of at least one ethylenically unsaturated monomer A with a solubility in water of >0.01 g/l at 25° C. and 1013 mbar,
(b) 0 to 50% by weight of at least one ethylenically unsaturated monomer B with a solubility in water of <0.01 g/l at 25° C. and 1013 mbar and
(c) 0 to 30% by weight of at least one ethylenically unsaturated monomer C with at least two double bonds.

3. The process according to claim 1, wherein use is made, as ethylenically unsaturated monomers, of
(a) methyl methacrylate, styrene, vinyl acetate, methyl acrylate, ethyl acrylate, ethyl methacrylate, n-butyl acrylate, isobutyl acrylate, tert-butyl acrylate, acrylic acid and/or methacrylic acid, acrylamide, methacrylamide, acrylonitrile and methacrylonitrile,
(b) if appropriate, lauryl acrylate, palmityl acrylate and/or stearyl acrylate, and
(c) if appropriate, butanediol diacrylate, allyl acrylate, allyl methacrylate, trimethylolpropane triacrylate, divinylbenzene, pentaerythritol triacrylate and/or pentaerythritol tetraacrylate.

4. The process according to claim 1, wherein use is made, as ethylenically unsaturated monomers, of
(a) methyl methacrylate, ethyl methacrylate and/or acrylic acid,
and
(c) butanediol diacrylate, pentaerythritol tetraacrylate, pentaerythritol triacrylate, trimethylolpropane triacrylate, allyl methacrylate and/or allyl acrylate.

5. The process according to claim 1, wherein at least one active substance is added during the emulsifying operation, then the monomers of the miniemulsion are polymerized up to a conversion of at most 50%, an aqueous macroemulsion of at least one ethylenically unsaturated monomer (c) with at least two double bonds in the molecule is subsequently metered in under polymerization conditions and, simultaneously or subsequently, the polymerization of the remaining monomers of the miniemulsion is brought to completion.

6. The process according to claim 1, wherein a solution of at least one active substance in at least one monomer is emulsified in water in the presence of at least one surface-active agent to give a miniemulsion, the monomers of the miniemulsion are polymerized up to a conversion of at most 35%, an aqueous macroemulsion of at least one ethylenically unsaturated monomer (c) with at least two double bonds in the molecule is subsequently metered in under polymerization conditions and, simultaneously or subsequently, the polymerization of the remaining monomers of the miniemulsion is brought to completion.

7. The process according to claim 5, wherein the monomers of the miniemulsion are first polymerized up to a conversion of at most 25%.

8. The process according to claim 1, wherein the oil phase of the miniemulsion comprises 0.5 to 60% by weight, with reference to the total amount of monomers used, of at least one pesticide.

9. The process according to claim 1, wherein the solution of at least one active substance in at least one monomer is emulsified in water in the presence of at least one nonpolymerizable hydrophobic compound.

10. An aqueous dispersion, which can be obtained according to a process according to claim 1.

11. An agrochemical formulation, which comprises an aqueous dispersion obtainable according to a process of claim 1.

12. (canceled)

13. A process for combating harmful microorganisms and/or for regulating the growth of plants and/or for combating undesirable plant growth and/or for combating undesirable insect or acarid infestation and/or for combating phytopathogenic fungi and/or for seed treatment, which comprises treating the undesirable microorganisms, phytopathogenic fungi and/or insects or acarids, their habitat or the plants, the soil or seeds of useful plants to be protected from microorganisms, fungal infestation or insect or acarid infestation or the undesirable plants with an effective amount of a pesticide formulation according to claim 11.

14. A process for combating undesirable plant growth, which comprises treating plants, the soil or their seeds with an effective amount of a pesticide formulation according to claim 11.

15. A seed, treated with at least one agrochemical formulation according to claim 11.
